(19) United States
(12) Patent Application Publication
(10) Pub. No.: US 2004/0052913 A1
(43) Pub. Date: Mar. 18, 2004

(54) Methods of maturing food

(76) Inventors: Yuichiro Uchida, Tottori-Ken (JP); Fumio Yukawa, Kanagawa-Ken (JP); Naoto Kobayashi, Kanagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,253

(22) PCT Filed: Mar. 20, 2002
(86) PCT No.: PCT/JP02/02712

(30) Foreign Application Priority Data
Mar. 21, 2001 (JP) 2001-80966

(51) Int. Cl. C12H 1/06

(52) U.S. Cl. 426/524; 426/237

(57) ABSTRACT

The object of the present invention is to provide a process for maturing a food which makes possible to control the maturation degree of the food.

Disclosed is a process for maturing a food characterized in that the maturation degree of the food is controlled by supplying energy 1 to a frozen food to control the period of time during which the food is maintained at a temperature in the neighborhood of its freezing point.

Disclosed is a process for maturing a food characterized in that the food is matured by supplying energy 2 to a frozen food to adjust the period of time during which the food is maintained at a temperature in the neighborhood of its freezing point to a predetermined value or more.

In a preferred embodiment, the melting time of a whole food is controlled by applying energy 3 which has a supplied calorie per unit time higher than that of energy 1 or 2 after the application of energy 1 or 2, and prolonging the application time of energy 3 to a predetermined value or more.

In a preferred embodiment, a step is added which is for making the temperature gradient in the interior of a food approximately constant by applying energy 4 having a supplied calorie per unit time lower than that of energy 3 after the application of energy 3.

### TECHNICAL FIELD

The present invention relates to a process for maturing foods, and more particularly, it relates to a process for maturing foods in which, during the thawing step of a frozen food, the maturation degree of the food is controlled to enable the food having the desired maturation degree such as improved taste to be prepared.

### BACKGROUND ART

The freshness and quality of foods is generally maintained by refrigeration or freezing storage processes which depend on the food types and the like, and various processing conditions have hitherto been examined in order to maintain the freshness and quality at high degrees.

With reference to the refrigeration storage process of foods, Japanese Patent Laid-Open Publication No. 11-46676 discloses a technique of achieving the maturation effect of a foodstuff having good freshness by storing the fresh foodstuff at an unfreezing temperature in the range of 0° C. or less to higher than the freezing point of it. However, this method is inconvenient in some points that the foodstuff can be practically controlled within the aforementioned temperature range only with difficulty from the technical viewpoint since it requires a high-precision refrigerator which can control temperature at a very narrow temperature range of about 3° C., it takes a lot of time for realizing the aforementioned temperature range of the whole foodstuff since rapid cooling of the foodstuff should be avoided in order to avoid the freezing of it, maturation effect can be obtained only insufficiently with the sacrifice of time, and the like.

Furthermore, with respect to the freezing storage process of foods, Japanese Patent Laid-Open Publication No. 9-252755(252755/1997) discloses a method for freezing, storing and thawing foods. The object of the method is to provide a combination process of freeing, storing and thawing which preserves foods with little degeneration of the quality at the time of preparation for a long time, that is, with preventing the deterioration after thawing, but the method is intended to maintain the freshness of foods by rapid thawing process to finish thawing within a time as short as possible, but not to obtain maturation effect.

### DISCLOSURE OF INVENTION

The object of the present invention is to dissolve the aforementioned problems and to control the maturation degree of a food to mature it so as to have the desired maturation degree.

As a result of earnest investigation in consideration of the aforementioned problems, the present inventors have found that such problems can be dissolved by adjusting energy supply during the thawing step of the frozen food, thereby controlling the time length of maintaining the food at a temperature in the neighborhood of its freezing point. The present inventors have completed the present invention on the basis of this finding.

That is to say, the process for maturing a food according to the invention is characterized in that the maturation degree of a food is controlled by supplying energy 1 to a frozen food to control a length of the period of time during which the food is maintained at a temperature in the neighborhood of its freezing point.

Further, the process for maturing a food according to the invention is characterized in that energy 2 is supplied to a frozen food to adjust the period of time during which the food is maintained at a temperature in the neighborhood of its freezing point to a predetermined period value or more to mature the food.

In one preferred embodiment of the invention, energy 3 having a supplied calorie per unit time higher than that of energy 1 or 2 is applied after the application of energy 1 or 2, and the period of time during which the energy 3 is applied is adjusted to a predetermined period value or more.

The present invention also relates to a food which is prepared according to the aforementioned maturation process.

### BRIEF DESCRIPTION OF THE DRAWINGS

FIG. 1 is a graph illustrating the thawing states with the passage of time of foods in the experiment 1 of maturation process (the present invention) of Examples.

FIG. 2 is a graph illustrating the thawing states with the passage of time in the experiment 3 of maturation process (Comparative Example: freezing-thawing; without maturation period) of Examples.

FIG. 3 is a graph illustrating the temperature variation with the passage of time in the experiment 4 of maturation process (Comparative Example: refrigeration; maturation for 3 hours) of Examples.

### BEST MODE FOR CCARRYING OUT THE INVENTION

Foods used in the invention include those which can be used for thawing after freezing storage such as a variety of foodstuffs, vegetables, rice, box lunches, raw fishery products, sashimi (sliced raw fishes), butcher's meats), sushi (vinegared fish and rice), and the like, but not limited thereto.

While the freezing condition of foods to be frozen is not specifically limited and any freezing conditions with respect to temperature, time, and the like may be used, rapid freezing within time as short as possible at any temperature usually in the range of freezing point or lower, desirably a temperature in the range of about −25° C. to about −60° C. is preferred. In this connection, foods before freezing may be intact, or may be in the form that the foods are packed with suitable packing materials to avoid the foods from being directly exposed to surrounding circumstances, for example bag type packages including pillow package in which conventional materials such as plastic film are used, box type packages, wrap type packages, shrink packages, or the like.

The process for maturing foods according to the invention basically comprises controlling the maturation degree of a food by supplying energy 1 to a frozen food to control a length of the period of time during which the food is maintained at a temperature in the neighborhood of its freezing point.

In another aspect of the invention, the process for maturing foods according to the invention is further characterized in that energy 2 is supplied to a frozen food to control a length of the period of time during which the food is maintained at a temperature in the neighborhood of its freezing point to a predetermined period value or more to mature the food.

The phraseology “temperature in the neighborhood of its freezing point” herein used means the temperature of the surface and/or the interior of foods usually in the range of −5° C. to 0° C.

In the present invention, the energy supplying sources applied to a food which may be used include hot or warm air as well as electromagnetic waves such as microwave and infrared rays, electric current, ultrasonic wave, and the like, and practically include, for example, a hot air heater as the hot air energy source; a microwave oven, an infrared heater, and a microwave heater as the microwave energy source; a low frequency induction heater as the electric current energy source; and an ultrasonic heater as the ultrasonic energy source. Thus, these energy supplying sources (means) as energies 1 and 2 may be used alone or in combination to control a length of the period of time during which the food is maintained at a temperature in the neighborhood of the freezing point. According to the invention, the period of time during which the food is maintained at a temperature in the neighborhood of the freezing point can be controlled or adjusted to a predetermined value or more to mature the food as well as to control the maturation degree including the degree of taste or enhance it to a given level (including a desired level) or more.

Energies 1 and 2 may be basically of the same condition except their difference in the features described above on the periods during which the food is maintained at a temperature in the neighborhood of the freezing point.

As described above, the maturation degree of a food can be controlled by controlling the period during which the food (surface and/or interior) is maintained at a temperature in the neighborhood of the freezing point, i.e. the maturation period, and the food can be matured to the desired degree by adjusting the period to a predetermined value or more, for example, 1 hour or more, preferably 2 hours or more. While prolonged maturation periods improves the taste of the food, in consideration of the factors such as thawing time fit to the practical process, it is practically at most 24 hours for raw products such as fresh meats and fresh fishes, and preferably about 3-5 hours for oshizushi (pressed, vinegared fish and rice) including fishery products.

In order to practically maintain the food at a temperature in the neighborhood of the freezing point during the maturation period, for example the energy supplying sources (means) described above may be used alone or in combination to control the strength, supply amount, and the like of the energy including heating temperature and electric current for adjusting the maturation period to the desired one under monitoring the surface and/or interior temperature of the food with a temperature sensor such as infrared sensor. Such maturation process can be practiced with any suitable method for the purpose, which can be precisely and efficiently by automatic control with a microcomputer.

The present invention is further described below particularly with reference to the preferred embodiments of the invention.

One preferred embodiment of the invention described above is a process for maturing a food in which after the application of energy 1 or 2, energy 3 having a supply calorie per unit time higher than that of energy 1 or 2 is applied and the application of energy 3 is adjusted to a predetermined period value or more to control the thawing time of the whole food.

This embodiment is intended to promote the thawing of a foodstuff the surface temperature of which has reached a temperature in the neighborhood of its freezing point by supplying said energy 1 or 2, wherein energy (energy 3) higher than said energy is applied to the foodstuff for a given period or more to realize the temperature involving at the central part of the foodstuff in the neighborhood of the freezing point as soon as possible. By way of example, after the surface temperature of the foodstuff is increased to the neighborhood of its freezing point using low temperature air by a hot air heater as energy 1 or 2, energy having a supply calorie per unit time higher than that of energy 1 or 2 is applied by electromagnetic wave irradiation as energy 3 with a microwave oven to realize the temperature involving at the central part of the foodstuff in the neighborhood of the freezing point as soon as possible.

Furthermore, the phrase “energy 3 is applied for a predetermined period or more” means that the energy is applied to a food for a period of time that a part of the interior of the food reaches a temperature in the neighborhood of the freezing point, or longer. In practice, for example, a combination of low temperature air as energy 1 or 2 and hot air at higher temperature as energy 3, or of low temperature air as energy 1 or 2 and electromagnetic wave irradiation (microwave oven) as energy 3 may be applicable, but the former combination is more desirable from the standpoint of the prevention of the generation of temperature increasing unevenness of the foodstuff. However, when electromagnetic wave irradiation method that heating can be controlled is used under the determination and monitoring of the surface temperature of the foodstuff mentioned above, the thawed product with high quality can be obtained with the latter combination.

Another preferred embodiment of the invention is a process for maturing a food wherein after the step of applying energy 3 is added a step wherein energy 4 having a supply calorie per unit time lower than that of energy 3 is applied to the food so that the temperature gradient within the food is made approximately constant.

This embodiment is intended to make the temperature distribution within a thawed foodstuff uniform by applying energy (energy 4) lower than energy 3 to a foodstuff in which thawing has been promoted at least to a part of the interior of a food by supplying said energies 1 (or 2) and 3, for example, by heating the foodstuff with warm air at about a finishing temperature for the food (e.g., about 25° C.) for a given period. For example, after applying energy 3 by electromagnetic wave irradiation, low temperature air as energy 4 lower than energy 3 is supplied at the time when a part of the interior of the foodstuff has been reach a temperature in the neighborhood of the freezing point to make the temperature distribution within the foodstuff uniform. In practice, a combination of high temperature air as energy 3 and low temperature air as energy 4, a combination of irradiation of electromagnetic wave irradiation (microwave oven) as energy 3 and low temperature air as energy 4, and irradiation of electromagnetic wave as both energies are applicable.

A further preferred embodiment of the above embodiment is the process for maturing a food, wherein energies 1, 2 and/or 4 is supplied mainly by low temperature air at a temperature in the range of higher than the freezing point of the food and 30° C. or less. The low temperature air is more preferably in the temperature range of 25° C. or less. Another preferred embodiment of the embodiment is a process for maturing a food, wherein energy 3 is mainly supplied by hot air at a temperature of higher than that of energy 1 or 2 and 60° C. or less. The hot air is more preferably in the temperature range of 25° C. to 40° C.

In the preferred embodiments of the invention, the surface temperature of the food is desirably controlled so that it does not excess a certain level, preferably 25° C.

As described above, the present invention relates to a process for maturing a food in which “good taste” of the food is generated and the degree of “good taste” is mainly controlled. In a typical embodiment, after a food is rapidly frozen (the more rapid freezing, the better), the foodstuff is thawed in the following three steps: (1) the foodstuff is warmed or heated with low temperature air (energy 1 or 2) at a temperature range of the one higher than the freezing point of the food to 25° C. for a predetermined period and the foodstuff is exposed in the neighborhood of a freezing point that the maturation effect on foods has been found, (2) energy higher than that in (1) above (energy 3) is applied to the foodstuff for a predetermined period so that the thawing is promoted to the central part, and (3) the foodstuff is heated with hot air at about the finishing temperature for a given period in order to unify the temperature within the foodstuff after thawing.

In this case, the generation and degree of “good taste” can be controlled by setting the periods and the temperatures in the step (1) that provides maturing effect, thereby controlling the period of time during which the food is maintained at a temperature in the neighborhood of the freezing point. In this connection, the maturation effect means the effects for removing “bad smell” and generating “good taste”.

The conventional refrigerating storage process, as described above, is intended to maintain a foodstuff just harvested at an non-freezing temperature ranging from 0° C. or less to the one higher than the freezing point of the foodstuff and thus to obtain the maturation effect with high freshness of the foodstuff. However, this process has disadvantages that the temperature of the foodstuff can be controlled practically within the aforementioned range only with technical difficulties, the foodstuff requires a very long time until the temperature of the whole foodstuff reaches the above described range, insufficient maturation effect is obtained with the time-consuming process, and the like. In the present invention, described above, in contrast with the conventional process, maturation effect is obtained also at a temperature below freezing point, so that temperature including the range in the freezing step and time can be controlled to bring about the maturation effect in a relatively short time.

The control process according to the invention can be practiced with a combination of any appropriate means fit for the respective features of the process of the invention as described above or with an apparatus provided with these means. That is to say, for example, the process for maturing a food according to the invention can be practiced by using an apparatus equipped with a combination of the energy supplying sources (means) as described above, i.e. hot or warm air, electromagnetic waves such as microwave and infrared rays, electric current, ultrasonic wave, and the like, in practice, including a hot air heater as the hot air means, a microwave oven, an infrared heater or an electromagnetic wave heater as the electromagnetic wave means, a low frequency induction heater as the electric current means, and an ultrasonic heater as the ultrasonic means, adjusting the strength, supply amount including heating temperature, current amount, and the like of energies 1 to 4 in the present invention so as to be fit for the features of the invention or particular embodiment described above, maintaining the food at a temperature in the neighborhood of its freezing point with monitoring the surface and/or interior temperature of the food with a temperature sensor such as an infrared sensor, and adjusting and controlling the maturation period to a certain or desired range. Such maturation process can be practiced with a combination of the means described above, which can be efficiently conducted by automatic control with a microcomputer.

An example of such apparatuses is a thawing apparatus of a food comprising the first thawing means in which the food is externally heated for at least a part of the thawing time of the food to increase temperature and melt for a part of the food and the second thawing means in which heat energy is preferentially supplied with electromagnetic waves to the molten part of the food by the first thawing means, in which

the first thawing means has the first output control means for adjusting amount of the external heating supply in the first thawing means depending on a deviation obtained by comparing the temperature of the food detected with a radiation heat sensor with a predetermined temperature memory value A in the electromagnetic wave irradiation process or another predetermined temperature memory value B in the external heating process in a predetermined temperature memory means, and

the second thawing means has a radiation heat sensor for detecting radiation heat emitted from the food, a predetermined temperature memory means for storing the given temperature, and the second output control means for adjusting the amount of the energy supply in the second thawing means depending on a deviation obtained by comparing the temperature of the food detected with a radiation heat sensor with a predetermined temperature memory value A in the predetermined temperature memory means.

With the aforementioned apparatus, temperature can be controlled in external heating by comparing the temperature of the food detected with a predetermined temperature value A in electromagnetic irradiation step or another predetermined temperature value B in the external heating process and increasing or decreasing amount of the external heating supply depending on the deviation, and temperature can also be controlled in electromagnetic wave irradiation by comparing the temperature of the food detected with a predetermined temperature value A and increasing or decreasing an amount of the energy supply of the electromagnetic wave depending on the deviation.

The means for external heating in the first thawing means comprises a hot or warm air heater which can supply hot or warm air at a constant temperature, and the second thawing means comprises the so-called microwave oven.

The radiation heat sensor comprises a well known non-contact type infrared sensor, and the predetermined temperature memory means comprises ROM installed in a microcomputer.

The first and second output control means comprise a heat supply amount control device or an electric power control device with feed back control by a microcomputer, and are intended to carry out feed back control of the external heating supply amount in the first step of the thawing process or the energy in the second thawing means.

The maturation degree of a food may be controlled by appropriately applying energies 1 to 4 in the present invention to the first or second thawing means depending on the features of the invention or particular embodiments described above according to the process of the invention or the processes of particular embodiments. In other words, the maturation degree of a food may be controlled by adjusting the time during which the food is maintained at a temperature in the neighborhood of its freezing point to the constant or desired level under monitoring and controlling the supply amounts of energies 1 to 4, the temperature of the food, and the like. In this invention, each energy supply amount (per unit time) of energies 1 to 4 may be constant during a given time of supply or may be adjusted by increasing or decreasing the amount with an appropriate gradient.

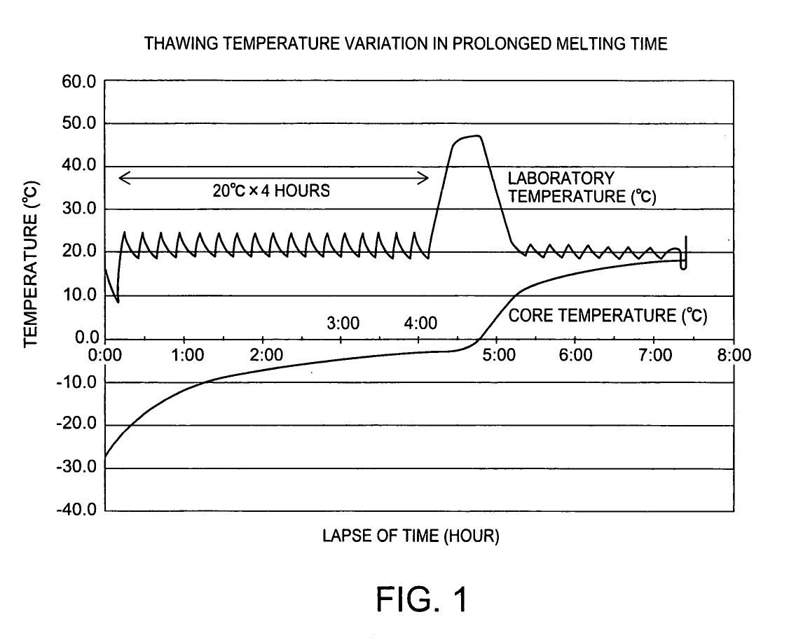

Specific examples with respect to the process of the invention and the results including Table 1 are illustrated in FIG. 1 in detail and in the following examples.

### EXAMPLES

The present invention is now described more specifically with reference to the following experimental examples and examples without limit thereto.

As a method for maturing a food in relation to the invention, three patterns of experiments in which the food is maintained at a temperature in the neighborhood of its freezing point (−4° C. to 0° C. in the exaample) for 4.5 hours (Example 1), 3 hours (Example 2), and 0.8 hour (Experimental Example 3) were conducted (these examples correspond to Nos. 1-3 in Table 1, respectively). In this connection, the pattern in Table 1 means the predetermined time for maintaining the food in an incubator, and the treatment (maturation and thawing) time represent the practical time during which the core temperature of the food has passed through the freezing temperature zone as a result of the treatment. Therefore, the time of “maturation/thawing” in the treatment time represent the maturation period. Also, as the comparative examples, maturation experiments were conducted on the cases that the food was maintained in an unfrozen state at the freezing temperature for 3 hours, and that the foodstuff was produced involving no refrigeration or freezing process.

As the food material, a plastic film pack of oshizushi that a fishery product was placed on vinegared rice (70 mm×40 mm×20 mm) and formed by pressing was used.

### Experimental Example 1 (Example 1)

In the first experiment, the food was rapidly frozen to a temperature of −30° C. and maintained at this temperature with a compression freezer combined with liquefied carbon dioxide gas. Then, in an approximately tight-sealed experimental apparatus, temperature was brought up to 20° C. with a heater within the apparatus, and forced convection was caused to the surface temperature of the foodstuff with a fan in order to maintain the core part of the foodstuff at a temperature in the neighborhood of the freezing point for about 4.5 hours. The laboratory was then allowed to warm to a temperature of about 48° C. by a heater, and maintained at the temperature for about 1 hour, so that the core temperature of the food was brought up to 0° C. or more for complete thawing. The laboratory temperature was subsequently dropped to 20° C., and mildly programmed so as the whole food to reach room temperature. Variations of the core temperature of the food and the room temperature with the passage of time in this case are shown in FIG. 1. In this connection, the core temperature of the foodstuff was determined with the passage of time by previously inserting a thermocouple into the core part of the foodstuff. Ten panelists evaluated the food by checking the feeling on eating of it, and gave the estimation of grade A in both good taste and odor (see No. 1 of Table 1).

In this connection, “freezing (refrigerating)” time in Nos. 1-3 of Table 1 means the time required for freezing the food to descend the core temperature to −25° C.

### Experimental Example 2 (Example 2)

The second experiment was approximately in the same manner as the first experiment, except that the food was maintained at a temperature in the neighborhood of the freezing point for 3 hours, and a microwave oven was used as the heating means in addition to the hot air heater in the experiment 1. The estimations of the test of feeling on eating the food in this case were grade B in good taste and A in odor, and proved that the time for maintaining it at a temperature in the neighborhood of the freezing point affected the feeling of eating it (see, No. 2 of Table 1)

### Experimental Example 3

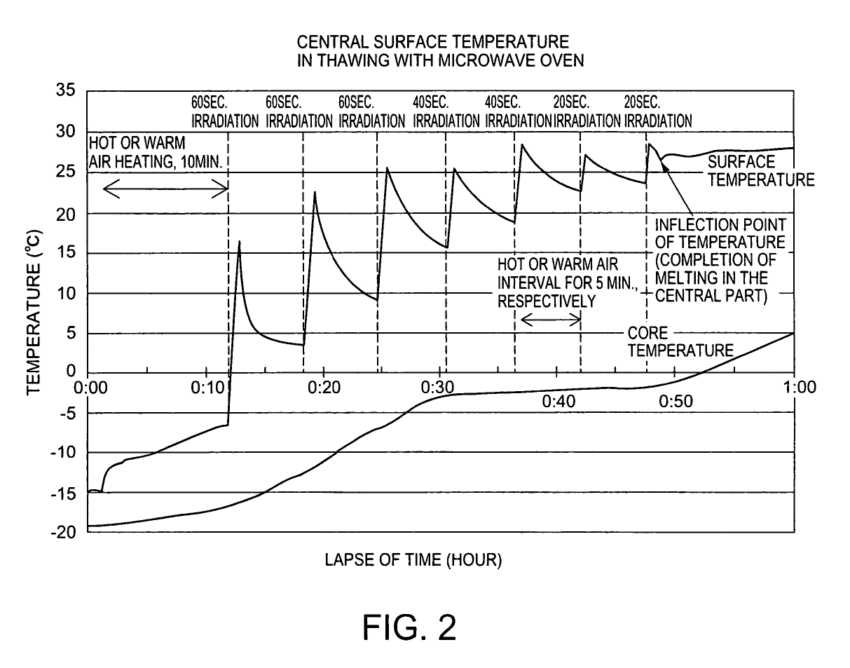

The third experiment was conducted for 0.8 hour as the time for maintaining the food at the temperature in the neighborhood of the freezing point (see FIG. 2). This was conducted on the basis of the assumption of the case that the food is mildly warmed to and passed through the freezing temperature without maintaining it at a constant temperature in the neighborhood of the freezing temperature. The estimations of the test of feeling on eating the food in this case were C in good taste and B in odor (see No. 3 of Table 1).

### Experimental Example 4

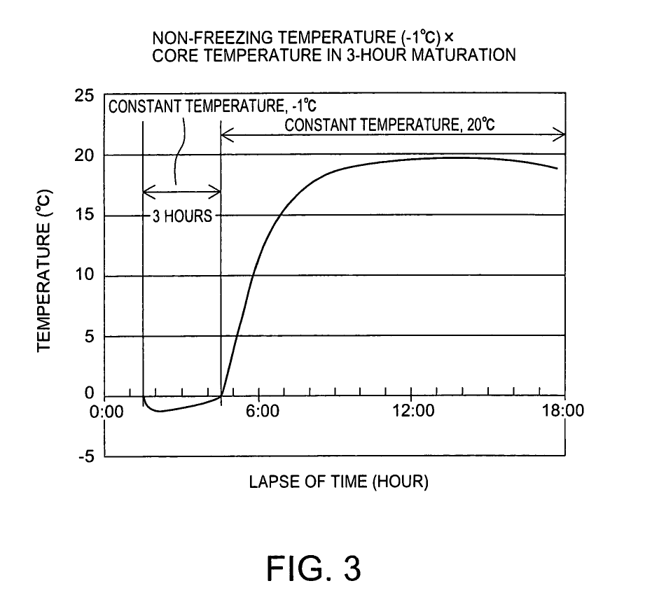

The fourth experiment was for the evaluation of the maturation degree of a food in refrigeration storage without freezing of the food. It was first cooled with a refrigerator over 6 hours to −3° C. at which the food was not frozen, and the core temperature of the food was maintained at a state of about −1° C. for about 3 hours. The experiment was carried out with attending the food as not being frozen during these periods. The food is then transferred to an experimental apparatus, the laboratory temperature was turned to 20° C. with a heater, and forced convection was caused to the surface temperature of the foodstuff with a fan in order to increase temperature mildly until the core part of the food reached at a temperature of 20° C. (see FIG. 3). The estimations of the test of feeling on eating the food in this case were B in good taste and A in odor (see No. 4 of Table 1).

In this connection, “freezing (refrigerating)” time in No. 4 of Table 1 means the time required for gradually cooling the food to lower a core temperature to −1° C.

### Experimental Example 5

In the fifth experiment, the test of feeling on eating a food was evaluated on the food which had been maintained at an ordinary temperature after production with no maturation process. The estimations of the test of feeling on eating the food in this case were D in good taste and C in odor (see No. 5 of Table 1).

The results of the maturation treatment experiments on the foods according to the process of the present invention are shown in the following Table 1, and the cases treated with the present process (Experiment Nos. 1 and 2) show clear maturation effect in comparison with the comparative examples (Experiment Nos. 3-5).

TABLE 1
The results of maturation treatment experiments

| | | | | | Treatment Time | | |
|---|---|---|---|---|---|---|---|
| | | | | | freezing | | |
| | | | | | (refrige- | maturation/ | |
| No. | Item | Patterns | GoodTaste | Odor | ration) | thawing | total |
| 1 | Freeze-Thaw- | Maturation | A | A | 3 hours | 4.5 hours | 7.5 hours |
| | Maturation 1 | Time of 4 hours | | | | | |
| 2 | Freeze-Thaw- | Maturation | B | A | 3 hours | 3 hours | 6 hours |
| | Maturation 2 | Time of 2 hours | | | | | |
| 3 | Freeze-Thaw- | No Maturation | C | B | 3 hours | 0.8 hour | 3.8 hours |
| | Maturation 3 | Time | | | | | |
| 4 | Refrigeration- | Maturation | B | A | 6 hours | 3 hours | 9 hours |
| | Maturation | Time of 3 hours | | | | | |
| 5 | No step for | | D | C | — | — | — |
| | Maturation | | | | | | |

*Estimation Criteria:
“Good Taste”: A, very strong; B, strong; C, a little; D, almost none.
“Odor”: A, No smell; B, a little smell; C, smell.

Industrial Applicability

According to the present invention, the desired degree of maturation effect of a food may be obtained by “adjusting a length of the periods of time, to control the maturation degree, during which the food is maintained at a temperature in the neighborhood of the freezing point” with the predetermined methods of energy supply as described above in the step of thawing the food which has been once frozen.

In addition, the following effects are obtained according to the present invention.

Temperature may be controlled easily on the freezing storage of foods, for example, any temperature may be used provided a freezing temperature of −25° C. or less.

Foods can be rapidly frozen and freeze-stored, and thus may be handled easily in practice.

Temperature is easily controlled on thawing of a food, that is to say, a foodstuff can be maintained automatically at a temperature in the neighborhood of the freezing point for a predetermined period since energy corresponding to the latent heat of melting is consumed without variation in temperature at the melting point of the foodstuff. Therefore, it is sufficient to add such quantity of heat as to melt the foodstuff only incompletely during the maturation period, and thus it is possible to control satisfactorily maturation degree of the food by only roughly adjusting energy supply, temperature or the like on the food.

It is believed that maturation effect may proceed also at a temperature below the freezing point of the food, and therefore maturation effect may be brought about within a short time by controlling temperature and time including the temperature range in the freezing process.

In oshizushi, smelling becomes stronger in proportion to the thickness of fish meat due to inherent problem of bad smell of fish meats, but this problem can be dissolved by maturation treatment at a temperature in the neighborhood of the freezing point according to the process of the invention.

What is claimed is:

1. A process for maturing a food characterized in that the maturation degree of the food is controlled by supplying energy 1 to a frozen food to control a length of the period of time during which the food is maintained at a temperature in the neighborhood of its freezing point.

2. A process for maturing a food characterized in that the maturation degree is controlled by supplying energy 2 to a frozen food to adjust a length of the period of time during which the food is maintained at a temperature in the neighborhood of its freezing point to a predetermined value or more.

3. A process for maturing a food according to claims 1 or 2, wherein the melting time of the whole food is controlled by applying energy 3 having a supplied calorie per unit time higher than that of energy 1 or 2 after the application of energy 1 or 2, and prolonging the application period of time of energy 3 to a predetermined value or more.

4. A process for maturing a food according to claim 3, wherein a step is added which is for making the temperature gradient in the interior of the food approximately constant by applying energy 4 having a supplied calorie per unit time lower than that of energy 3 after the application of energy 3.

5. A process for maturing a food according to any one of claim 1-4, wherein energies 1, 2 and/or 4 are supplied mainly by low temperature air in the temperature range from higher than the freezing point of the food to 30° C. or less.

6. A process for maturing a food according to any one of claim 3-5, wherein energy 3 is supplied mainly by hot air in the temperature range from higher than the temperature of energy 1 or 2 to 60° C. or less.

7. A process for maturaing a food according to claim 2, wherein the predetermined value of the period during which the food is maintained at a temperature in the neighborhood of the freezing point is 3 hours or more.

8. A food prepared by a process according to any one of claims 1-7.
